(19) United States
(12) Patent Application Publication
(10) Pub. No.: US 2008/0244207 A1
(43) Pub. Date: Oct. 2, 2008

(54) System as well as a method for granting a privilege to a chip holder

(75) Inventors: Wilhelmus Kamminga, Weert (NL); Jacobus Gabriel Maria Bril, Winssen (NL)

Correspondence Address: WOOD, PHILLIPS, KATZ, CLARK & MORTIMER, 500 W. MADISON STREET, SUITE 3800, CHICAGO, IL, 60661, US

(73) Assignee: King Sized Men B.V.

(21) Appl. No.: 11/729,813

(22) Filed: Mar. 29, 2007

(51) Int. Cl. G06F 12/00

(52) U.S. Cl. 711/164

(57) ABSTRACT

A system for granting a privilege to a chip holder. The system comprises at least one chip provided with at least one secret key to be activated by a chip holder and at least one associated public key. The system further comprises at least one chip reader, which is connected to a device for carrying out the privilege, and at least one privilege database, which comprises data regarding privileges associated with respective chips. In the system a request route and a reply a route are set up between the chip reader and the privilege database over at least one network, wherein a reply from the privilege database can be sent to the chip reader in encoded form via the reply route by means of a public key of the chip obtained from an encryption database. The chip holder can decode the reply by means of the secret key, after which the decoded reply can be transferred to the device for carrying out the privilege.

The invention relates to a system for granting a privilege to a chip holder, as well as to a method for granting a privilege to a chip holder.

Systems that grant privileges to persons are known per se. The privilege to be granted may be the opening of a door in a building, for example. Systems of this kind may be provided with a chip for identifying the chip holder. Said identification may be realised by moving a chip through a chip reader, after which a verification is carried out in a central database whether the chip being moved through the chip reader, and thus the chip holder, has access to the door in question.

A drawback of the above system is the fact that such a system is not automatically suitable for being used over a public network such as the Internet, for example. Sending the privilege over the network in a secure manner requires the use of several complex security measures. The implementation of such security measures increases the costs of such a system.

Another drawback is the fact that in the above system the chip in itself already provides access. No additional identification step is carried out so as to verify whether the person who inserts the chip into the chip reader is actually the chip holder.

It is therefore an object of the invention to provide a system by which a secured privilege is granted to a chip holder in a comparatively simple manner.

This object is achieved by means of the system according to the present invention, which comprises:

at least one chip provided with at least one secret key to be activated by a chip holder and at least one associated public key,

at least one chip reader, which is connected to a device for carrying out the privilege,

at least one privilege database, which comprises data regarding privileges associated with respective chips, wherein a request route and a reply a route can be set up between the chip reader and the privilege database over at least one network, wherein a reply from the privilege database can be sent to the chip reader in encoded form via the reply route by means of a public key of the chip obtained from an encryption database, which reply can be decoded by means of the secret key by the chip holder, after which the decoded reply can be transferred to the device for carrying out the privilege.

Using the above system, requesting a privilege can be done in a simple and secure manner over any network, in that a privilege of a chip holder is sent over a network in the form of an encoded reply. Furthermore, the system also comprises a verification step for confirming the identity of the chip holder. The fact is that said decoding and said confirmation of the identity are carried out in a single step. The moment the decoded reply is received by the chip reader, both the identity of the chip holder is verified and the reply from the privilege database is decoded by activating the secret key that is only known to the chip holder.

The privilege may be an electronic amount of money, for example, an access code for a website, a ticket to a concert or access to an elevator. When the chip is inserted into a chip reader that is connected to a device for carrying out the privilege, for example a computer, an elevator or an entrance gate, a request route is set up over a network between the chip reader and a privilege database that comprises data regarding privileges associated with respective chips. Then a reply from the privilege database is sent by means of an encryption database to the chip reader in encrypted or encoded form in a reply route.

A chip that is not known in the privilege database receives a reply that does not comprise a privilege, whereas a chip that is known in the database receives a reply that may comprise a privilege. The chip reader is connected/linked to the device for carrying out the privilege for the purpose of forwarding the encoded reply.

Furthermore, the risk of the wrong party receiving the privilege when the privilege is sent over a random network is small, because encryption with a sufficiently large asymmetric key pair makes it virtually impossible to crack the reply.

Another advantage of the present invention is the fact that only one chip is needed in the system according to the present invention for requesting privileges that are normally granted by various providers. This can be done by setting up connections with various privilege databases, each privilege database comprising an encryption database. Depending on the device for carrying out the privilege, a request route is set up with the privilege database that manages the privilege in question. Since each privilege database comprises an encryption database comprising the public key of the chip, the reply can be sent to the chip reader in encoded form. In this way a number, which may in principle be an infinite number of privileges, can be requested by means of a single chip.

US2003/0144960 describes a method of commercial distribution of digital products by a network. Said method aims to protect digital products against pirating by comprising said digital product with a separate file of rights of use data, said rights of use data being sent encrypted according to an encryption code for which a secret decryption key is stored in the memory of electronic means of payment, e.g. a payment card. For using said digital product it is indispensable that said rights of use data is decrypted with the aid of said decryption key.

A main difference between the present invention and the method/system known from US2003/0144960, is that the system/method according to the present invention grants a privilege(s) in a secure and simple way. Although a privilege database as a verification computer server (V, FIG. 3), is known from US2003/0144960, a reply from this known privilege database is not sent to the chip reader in encoded form via the reply route by means of a public key of the chip obtained from an encryption database. In addition, a verification in the request route, by means of the PIN code, is necessary in the known method for initiating the process (see paragraph 67), whereas in the system and method according to the present invention only one verification/authentication step is necessary, in which step simultaneous the reply of the privilege database is decoded.

US2005/0001028 relates to a method of authenticating the use of a vehicle or the entry to a building. In this known method the process is also initiated in the request route by identification by means of a PIN code. As is already described above for the present invention, identification and decoding are performed in one single step in a reply route. Further, the reply from the third party in US2005/0001028 granting or not granting a privilege is not encoded by means of a public key of the chip obtained from an encryption database (step 576 in FIG. 5B).

One embodiment of the system according to the present invention is characterised in that conditions associated with a privilege are stored in the privilege database.

The power to decide whether a privilege will be granted, and on what conditions, lies entirely with the privilege database. As a result, the chip reader and the device connected thereto may be of comparatively simple design. One such condition is, for example, the balance on a chip holder's account. The moment said balance is insufficient, the chip (holder) will receive a negative reply from the privilege database upon attempting to make a payment.

Furthermore, it is possible to give a person access on certain conditions, for example only the right of access to a building X between 9.00 and 17.00 hours. By only providing the central database with intelligence, i.e. functions for verifying the time, the balance, the position of the chip holder, etc, only the spider in the web, viz. the privilege database, needs to be provided with means for verifying the conditions (for example a clock, a connection to a balance database, etc). As a result, the device for carrying out the privilege may be of comparatively simple design.

Another embodiment of the system according to the invention is characterised in that the reply from the privilege database can be decoded only once, in which case a privilege that has been sent can be carried out only once by means of the device.

After the reply has been decoded, it is preferably directly communicated to the device via a connection, whereupon the privilege is carried out. Preferably, the reply is a privilege that depends on certain conditions. Since conditions may change over time, it is preferably not possible to store the encoded or decoded reply on a medium for subsequent decoding. By using a once-only decoding and subsequent execution of a privilege by the device it is ensured that all operations will be carried out over a minimum period of time, thus minimising the possibility of the conditions changing between the requesting of a privilege and the actual execution of the privilege.

Another embodiment of the system according to the present invention is characterised in that a granted privilege has a limited period of validity after being sent from the privilege database.

By selecting a sufficiently short period of validity it is thus achieved in a simple manner that a privilege in the form of an access code can be used only once. Furthermore, by connecting a period of validity to a privilege the possibility of an intercepted encoded reply being used is eliminated. The fact is that cracking the reply code takes computer time, and by selecting a sufficiently short period of validity in relation to the minimally required computer time the possibility of a cracked reply code producing a usable privilege is eliminated. Furthermore, the use of a short period of validity makes it possible to use comparatively simple keys (for example a 256-bit key) which in themselves are capable of being cracked.

Another embodiment of the system according to the invention is characterised in that the system comprises an independent communication apparatus, which comprises at least a server and an encryption database.

By providing an independent communication apparatus, only one encryption database needs to be used in the system according to the invention, since it is possible to set up a request route with several privilege databases by means of the server. The replies are sent over the reply route in encoded form by means of the encryption database of the independent communication apparatus.

Yet another embodiment of the system according to the present invention is characterised in that a separate network connection is to be set up for transmitting the reply between the privilege database and the independent communication apparatus.

The separate network connection is preferably a secured connection, so that a secure exchange of the reply is guaranteed.

Another embodiment of the system according to the invention is characterised in that the reply can be sent from the privilege database to the independent communication apparatus in encoded form by means of symmetric or asymmetric key pairs.

As a result of the use of such key pairs, which are only known to the privilege database and to the independent communication apparatus, a secure exchange of data, for example over a comparatively insecure network, is ensured.

Another embodiment of the system according to the invention is characterised in that the secret key of the chip can be activated by inputting at least a PIN code into the chip reader.

The PIN code is used for verifying the identity of the chip holder. Additionally, at least one biometric characteristic of the chip holder might be verified as well.

Another embodiment of the system according to the present invention is characterised in that a key is at least a 1024 bit key.

The use of a 1024 bit key ensures a secure connection. If a higher degree of security is required, a 2048 bit key or a 4096 bit key may be used. If a period of validity of the privilege is used as described above, it will also be possible to use shorter keys.

Yet another embodiment of the system according to the invention is characterised in that an identification of the chip as well as an identification of the device can be sent to the privilege database for setting up the request route.

In particular in a system in which a privilege database can be connected to various chip readers via reply routes, the privilege database requires an identification of the chip in order to be able to verify whether a chip comprises a privilege. The privilege database furthermore requires an identification of the device for setting up the reply route. Also in the situation in which a chip reader can be connected to various privilege databases via the independent server, an identification of the device is required for setting up a request route and a reply route with the privilege database.

Another embodiment of the system according to the present invention is characterised in that the chip reader can be connected to the device for carrying out the privilege.

The chip holder is capable of connecting the chip reader, which has comparatively small dimensions, to various devices for carrying out privileges in a simple manner. Said connecting may also take place wirelessly, for example via networks having a comparatively small range, via an infrared communication port or via Bluetooth, or via networks having a comparatively large range, for example UMTS or GPRS. If the chip reader to be connected has been assigned to a chip holder, an identification of the chip reader rather than an identification of the chip may be sent for the purpose of setting up a connection between the chip reader and the privilege database.

Another embodiment of the system according to the present invention is characterised in that the request route and/or the reply route can be realised over a wireless network.

In principle no demands are made on the network, so that any wireless network, for example UMTS or GPRS, may be used for the request route and/or the reply route.

Another embodiment of the system according to the present invention is characterised in that the chip is integrated in the chip reader.

In the case of a chip reader that has been assigned to the chip holder for setting up a connection, the chip may be integrated in the chip reader. Leaving out receiving means for the chip moreover makes it possible to use a chip reader of smaller dimensions, so that it will be easier to carry along, for example in an inside pocket.

Another embodiment of the system according to the invention is characterised in that the chip is provided with at least one further encoding means, such as an asymmetric or a symmetric key, for encoding identification means of the chip, with the independent communication apparatus being provided with associated decoding means.

Such further encoding means make it possible to request a privilege anonymously by means of the system according to the invention. The anonimity in the request route to the independent communication apparatus is ensured for example by sending an identification of the chip to the independent communication apparatus in encoded form. The identification of the chip is decoded in the independent communication apparatus and sent to a privilege database. The identification of the device is not sent to the privilege database. The privilege database thus knows the identity of the chip that is making a request but it does not know the location at which the privilege has been requested. The device for carrying out the privilege, on the other hand, does not receive any (decoded) data about the identity of the chip (holder). Such an application makes it possible to effect payments anonymously. Instead of the chip, also an assigned chip reader, as explained above, may be provided with further encoding means.

The chip reader may for example be provided with a function to be performed, so that the chip being passed through the chip reader will encode the identification means of the chip, as a result of which the identification means of the chip will only exit the chip reader in encoded form. The independent communication apparatus may then decode and forward the identification means of the chip, using further corresponding decoding means.

Another object of the present invention is to provide a method by means of which a secure privilege is granted to a chip holder in a comparatively simple manner.

This object is achieved by means of the method according to the present invention which comprises the steps of:

activating a chip provided with a public key and a secret key in a chip reader,

setting up a request route between the chip reader and a privilege database which comprises data regarding privileges associated with respective chips,

setting up a reply route between the privilege database and the chip reader,

encoding a reply from the privilege database by means of an encryption database that comprises the public key of the chip,

the chip holder decoding the reply, using the chip reader, by activating the secret key of the chip,

communicating the decoded reply to a device for carrying out the privilege.

In this way a privilege can be sent to a chip holder in a secure manner over a comparatively insecure network, using comparatively simple means.

Another embodiment of the method according to the invention is characterised in that an identification of the chip as well as an identification of the device for carrying out the privilege is sent to the privilege database in the request route.

In this way it can be ascertained in a comparatively simple manner on the basis of the identification of the chip whether a chip is entitled to a privilege, and the reply route can be set up in a simple manner on the basis of the identification of the device.

Another embodiment of the method according to the invention is characterized in that the request route and the reply route are set up by means of an independent communication apparatus comprising the encryption database and a server.

As a result of the use of the independent communication apparatus, only one encryption database is required in a system comprising various privilege databases. Furthermore it is possible in a comparatively simple manner to request a privilege anonymously by providing further encoding means in the chip or the chip reader and decoding means in the independent communication apparatus.

Another embodiment of the method according to the present invention is characterised in that the privilege database determines on what conditions a privilege is to be granted.

Providing the privilege database with intelligence enables the privilege database to make a decision as to whether the conditions for a particular privilege associated with a chip have been complied with.

Yet another embodiment of the method according to the invention is characterised in that the period of validity of a granted privilege is determined by means of the privilege database.

This makes it possible to prevent a privilege being used more than once and to eliminate the risk of a cracked reply still being valid.

Another embodiment of the method according to the present invention is characterised in that the reply is decoded only once by means of the chip reader, after which a privilege comprised in the reply is carried out by means of the device for carrying out the privilege.

This strict time sequence of operations ensures that the period of time during which the conditions may change will be sufficiently small.

The invention will now be explained in more detail with reference to an appended figure in combination with a few embodiments.

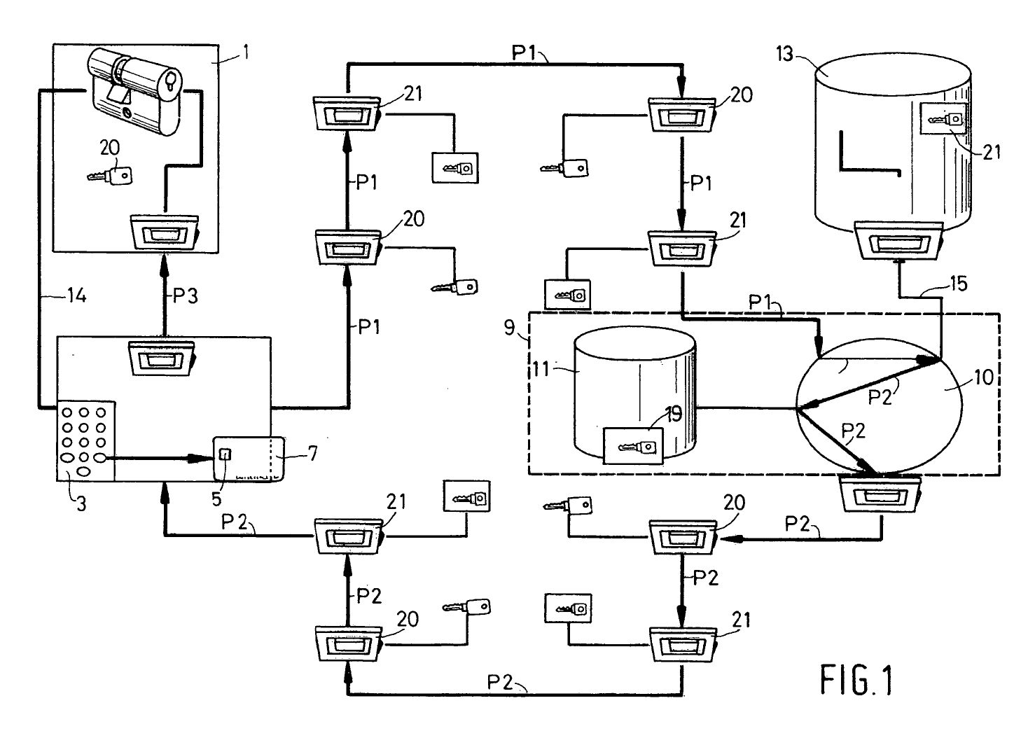

FIG. 1 is a schematic view of the system according to the present invention.

The system as shown in FIG. 1 essentially comprises the following elements:—a device 1 for carrying out a privilege,—a chip reader 3 as well as a chip 5 that is integrated in a smart card 7,—an independent communication apparatus 9 comprising a server 10 and an encryption database 11, and—a privilege database 13.

The chip 5 is a secured processor.

To request a privilege, the chip holder inserts the chip 5 into a chip reader 3. The chip reader 3 itself is connected to the device 1, via the connection 14, to the device 1 for carrying out the privilege.

By positioning the chip 5 in the chip reader that is connected to the device 1, a request route as indicated by the arrows P1 is set up between the chip reader 3 and the independent communication apparatus 9.

In the server 10 the reply route is extended by effecting a connection 15 between the independent communication apparatus 9 and the privilege database 13.

The privilege database 13 has privileges of several chips 5 stored therein. If a chip 5 is known to the privilege database 13, a reply comprising a privilege is sent to the server 10 via the connection 15. The reply route comprising the reply from the privilege database 13 is indicated by the arrows P2. The reply from the privilege database 13 is encrypted by means of the server 10 and the encryption database 11, which comprises a public key 19 of the chip 5. The encrypted reply is sent to the chip reader 3 by means of the server 10 in the reply route.

In the chip reader 3, the identity of the chip holder is verified by decoding the reply. The secret key (not shown) is activated in the chip 5 by inputting a correct PIN code into the chip reader 3. The reply can only be decoded by means of the secret key. The secret key and the public key 19 from the encryption database 11 together form an asymmetric key pair.

If the decoded reply comprises a privilege, this is directly communicated to the device 1 for carrying out the privilege via a connection that is indicated by the arrow P3.

As an additional step, the chip reader 3 may deliver a public key of the chip 5 to the device 1 the moment the request route P1 is set up. By further encoding the decoded reply in the chip reader 3 with the secret key of the chip 5, the connection P3 can be carried out over any network. The device 1 can then decode said reply by means of the previously received public key for carrying out the privilege.

As is indicated by numerals 20, 21 in FIG. 1, additional securing steps in the form of asymmetric keys 20, 21 may be carried out. Said securing steps may be partially comprised within the chip reader with a view to making anonymous privilege requests. The key illustrated at 20 represents a coding/decoding step by means of a secret key, whilst the certificate indicated at 21 represents a public key. It is also possible to use other keys, for example symmetric keys. Optionally the public key 21 shown in the privilege database 13, which is the public key associated with the secret key of the device 1, may additionally encode the reply.

In one embodiment of the system according to the present invention the device 1 is an elevator 1. The chip reader 3 is mounted in a wall near the elevator. The elevator 1 is not a public elevator 1, and the doors are only opened on certain conditions.

A person in possession of a smart card 7 provided with a chip 5 inserts the chip 5 into the chip reader 3. Once the request route P1 has been effected and the person is known to the privilege database 13 via the chip, the privilege is sent to the chip reader 3 in the form of an encrypted reply via the reply route P2, provided the person in question is authorized to do so. Encoding the reply makes it possible to effect the reply route P2 over a comparatively insecure network, just like the request route. The identity is verified after the chip holder has input the PIN code into the chip reader 3. By inputting the correct PIN code, the secret key of the chip 5 is activated and, in addition to the identification step, the reply is simultaneously decoded. The decoded reply, which comprises the privilege of the chip (holder), is now transferred to the elevator 1, which opens the elevator doors.

Such a system is for example advantageous for use in buildings of a single company situated at locations remote from each other (in different countries). Since no requirements are made as regards the security of the network, use may be made of the Internet for the system according to the present invention. As a result, a building in Australia and a building in the Netherlands may both be secured with the system according to the present invention.

The system according to the present invention is also suitable for requesting a privilege anonymously or for making a payment anonymously. The device 1 for carrying out a privilege is in this case a point-of-sale terminal 1, for example. It may be a conventional point-of-sale terminal, in which the chip reader 3 is integrated. It may also be a point-of-sale terminal 1 that is connected to an assigned (associated with the chip holder) chip reader. The moment a chip holder has to pay an amount of money at the point-of-sale terminal 1, which amount is communicated to the chip reader 3 together with the identification of the point-of-sale terminal via the connection 14, a request comprising said amount of money, an identification of the point-of-sale terminal and an identification means of the chip, for example the chip number, is sent to the independent communication apparatus 9 in the request route P1 from the chip reader 3. In the case of an anonymous payment, said request is encoded in the chip or in the assigned chip reader. The server 10 of the communication apparatus 9 comprises means or is connected to means (not shown) for decoding the request. Following that, the server 10 will only communicate the amount of money and the chip number to the privilege database 13 of a bank. If the chip number is found in the database 13 and the balance is sufficient, a reply in the form of electronic money is sent to the server 10. In the server 10, the reply is encoded with the public key 19 of the chip number by means of the encryption database 11. Following that, the server 10 sends the encoded reply to the chip reader 3 via the reply route P2 on the basis of the identification of the point-of-sale terminal. A payment is effected the moment the secret key of the chip 5 is activated by means of the chip reader 3. When such a transaction is carried out, the bank does not know where the money was spent, because the server 10 does not communicate all the data to the bank's privilege database 13, whilst the point-of-sale terminal 1 does not receive any data regarding the chip holder's identity.

If the device 1 is a computer, the privilege provides access to, for example, web pages with a specific content, for example music, or to a company's intranet. The computer may also provide access to databases that comprise digital documents or files, or to the Internet.

In an especially preferred embodiment, several privileges can be obtained by means of a single chip 5. For example, the same chip 5 may be used with the computer, the point-of-sale terminal and the elevator, etc.

It is also possible to leave out the independent communication apparatus 9, in which case each privilege database 13 must be provided with its own encryption database 11.

Preferably, conditions of a privilege are stored in the privilege database 13 and the reply from the privilege database 13 can be decoded only once, in which case a transmitted privilege can be carried out only once by means of the device 1. This is done in order to prevent a situation in which the circumstances have changed too much over time, as a result of which the privilege is no longer valid. Preferably, a granted privilege comprises a period of validity.

In principle the privilege is an activation code for the device 1 for activating a privilege. In some applications of the system according to the present invention it is possible to store a decoded activation code, in which case the activation code may have a specific period of validity.

The connection 15 between the independent communication apparatus 9 and the privilege database 13 and the connections 14, P3 between the chip reader 3 and the device 1 are preferably network connections that have been secured separately or by means of symmetric or asymmetric key pairs.

The device for carrying out a privilege is preferably a means that provides physical or logical access to privileges associated with a chip holder. Thus, a device may be a lock for opening a door, and elevator or for starting a car. However, it may also be a computer or an automaton such as a beverage vending machine or a point-of-sale terminal. Furthermore the device may be a “smart box”, by means of which a chip holder is granted access to digital television, telephone applications, etc.

Furthermore, the chip reader may be integrated in the device for carrying out the privilege, for example in the case of a conventional point-of-sale terminal. The chip reader may also be integrated in a PDA or in a smart phone.

The present invention furthermore does not make any demands on the required networks, so that it is also possible to use wireless networks, if desired.

1. A system for granting a privilege to a chip holder, which system comprises:
at least one chip provided with at least one secret key to be activated by a chip holder and at least one associated public key,
at least one chip reader, which is connected to a device for carrying out the privilege,
at least one privilege database, which comprises data regarding privileges associated with respective chips, wherein a request route and a reply a route can be set up between the chip reader and the privilege database over at least one network, wherein a reply from the privilege database can be sent to the chip reader in encoded form via the reply route by moans of a public key of the chip obtained from an encryption database, which reply can be decoded by means of the secret key by the chip holder, after which the decoded reply can be transferred to the device for carrying out the privilege.

2. A system according to claim 1, characterised in that conditions associated with a privilege are stored in the privilege database.

3. A system according to claim 2, characterised in that the reply from the privilege database can be decoded only once, and a privilege that has been sent can be carried out only once by means of the device.

4. A system according to claim 1, characterised in that a granted privilege has a limited period of validity after being sent from the privilege database.

5. A system according to claim 1, characterised in that the system comprises an independent communication apparatus, which comprises at least a server and the encryption database.

6. A system according to claim 5, characterised in that a separate network connection is to be set up for transmitting the reply between the privilege database and the independent communication apparatus.

7. A system according to claim 5, characterised in that the reply can be sent from the privilege database to the independent communication apparatus in encoded form by means of symmetric or asymmetric key pairs.

8. A system according to claim 1, characterised in that the secret key of the chip can be activated by inputting at least a PIN code into the chip reader.

9. A system according to claim 1, characterised in that a key is at least a 1024 bit key.

10. A system according to claim 1, characterised in that an identification of the chip as well as an identification of the device can be sent to the privilege database for setting up the request route.

11. A system according to claim 1, characterised in that the chip reader can be connected to the device for carrying out the privilege.

12. A system according to claim 1, characterised in that the request route end/or the reply route can be realised over a wireless network.

13. A system according to claim 11, characterised in that the chip is integrated in the chip reader.

14. A system according to claim 5, characterised in that the chip is provided with at least one further encoding means, such as an asymmetric or a symmetric key, for encoding identification means of the chip, with the independent communication apparatus being provided with associated decoding means.

15. A method for granting a privilege to a chip holder, comprising the steps of:
activating a chip provided with a public key and a secret key in a chip reader,
setting up a request route between the chip reader and a privilege database which comprises data regarding privileges associated with respective chips,
setting up a reply route between the privilege database and the chip reader,
encoding a reply from the privilege database by means of an encryption database that comprises the public key of the chip,
the chip holder decoding the reply, using the chip reader, by activating the secret key of the chip,
communicating the decoded reply to a device for carrying cut the privilege.

16. A method according to claim 15, characterised in that an identification of the chip as well as an identification of the device for carrying out the privilege is sent to the privilege database in the request route.

17. A method according to claim 15, characterised in that the request route and the reply route are set up by means of an, independent communication apparatus comprising the encryption database and a server.

18. A method according to claim 15, characterised in that the privilege database determines on what conditions a privilege is to be granted.

19. A method according to claim 15, characterised in that the period of validity of a granted privilege is determined by means of the privilege database.

20. A method according to claim 15, characterised in that the reply is decoded only once by means of the chip reader, after which a privilege comprised in the reply is carried out by means of the device for carrying out the privilege.
